(19) United States
(12) Patent Application Publication
(10) Pub. No.: US 2002/0107695 A1
(43) Pub. Date: Aug. 8, 2002

(54) Feedback for unrecognized speech

(76) Inventors: Daniel L. Roth, Boston, MA (US); Jordan Cohen, Gloucester, MA (US)

Correspondence Address: BRIAN J. COLANDREO, Fish & Richardson P.C., 225 Franklin Street, Boston, MA, 02110-2804, US

(21) Appl. No.: 09/779,426

(22) Filed: Feb. 8, 2001

(51) Int. Cl. G10L 21/00

(52) U.S. Cl. 704/275

(57) ABSTRACT

A feedback process for providing feedback for unrecognized speech includes a speech input process for receiving a speech command as spoken by a user. An unrecognized speech comparison process, responsive to the speech input process, compares the user's speech command to a plurality of recognized speech commands available in a speech library to determine if the user's speech command is unrecognized speech, as opposed to non-speech.

### TECHNICAL FIELD

This invention relates to voice recognition systems, and more particularly to voice recognition systems which provide feedback for unrecognized speech.

### BACKGROUND

Voice recognition systems allow for the convenient and efficient conversion of spoken commands (or words) to system-recognizable commands (or computer text). These spoken commands can be discrete commands which perform specific functions in a system (e.g. sort files, print files, open files, close files, start the system, shut down the system, etc.) or they can be spoken words when the voice recognition system is utilized for dictation. Typically, an acoustic model is created for each spoken command or word received by the voice recognition system. This acoustic model is then compared to the acoustic model of each command or word included in the voice recognition system's library. Each one of these comparisons results in an acoustical score (often a probability ranging from 0.0 to 1.0). The voice recognition system then makes a determination concerning what command or word the user is saying based on the comparison of these acoustical scores, possibly in conjunction with a language model

Therefore, the accuracy of a voice recognition system is maximized when the user of the system pronounces these commands (or words) substantially similar to the commands (or words) in the system's library. When the voice recognition system unambiguously recognizes the commands (or words) the user is saying, the voice recognition system takes the appropriate action (e.g., executes the spoken commands or enters the spoken text). When, for various reasons, the voice recognition system cannot accurately match the commands (or words) that the user is saying to those available in the voice recognition system's library, the voice recognition system will respond in one of several ways. If the voice recognition system is used for dictation purposes or to control the functionality of a device, the voice recognition system will typically provide a best guess, and then optionally a list of potential matches, where the user can scroll through a menu and select the appropriate command (or word) from the list. If the voice recognition system is used for entertainment purposes (e.g., in a child's toy), the voice recognition system typically will not provide any response for ambiguous commands (or words), even if the voice recognition system realizes that these ambiguous commands (or words) are speech. Needless to say, this situation can be frustrating to children who require interaction and constant feedback to maintain their interest.

### SUMMARY

According to an aspect of this invention, a feedback process for providing feedback for unrecognized speech includes a speech input process for receiving a speech command as spoken by a user. An unrecognized speech comparison process, responsive to the speech input process, compares the user's speech command to a plurality of recognizable speech commands available in a speech library to determine if the user's speech command is unrecognized speech, as opposed to non-speech.

One or more of the following features may also be included. The feedback process further includes an unrecognized speech response process, responsive to the unrecognized speech comparison process determining that the user's speech command is unrecognized speech, for generating a generic response which is provided to the user. The generic response is a visual response. The generic response is an audible response. The unrecognized speech comparison process includes a user speech modeling process for performing an acoustical analysis of the user's speech command and generating a user speech acoustical model for the user's speech command. The unrecognized speech comparison process further includes a recognized speech modeling process for performing an acoustical analysis of each of the plurality of recognized speech commands and generating a recognized speech acoustical model for each recognized speech command, thus generating a plurality of recognized speech acoustical models. The unrecognized speech comparison process further includes an acoustical model comparison process for comparing the user speech acoustical model to each of the recognized speech acoustical models, thus defining a plurality of acoustical scores which relate to the user's speech command, one score for each comparison performed. The unrecognized speech comparison process further includes an unrecognized speech window process for defining an acceptable range of acoustical scores indicative of unrecognized speech, wherein the user's speech command is defined as unrecognized speech if the acoustical score, chosen from the plurality of acoustical scores, which indicates the highest level of acoustical match falls within the acceptable range of acoustical scores. The plurality of recognized speech commands includes an unrecognized speech entry, the recognized speech modeling process further performs an acoustical analysis on the unrecognized speech entry to generate an unrecognized speech acoustical model for the unrecognized speech entry, and the acoustical model comparison process further compares the user speech acoustical model to the unrecognized speech acoustical model to define an unrecognized speech acoustical score. The user's speech command is then defined as unrecognized speech if the unrecognized speech acoustical score indicates a higher level of acoustical match than any of the plurality of acoustical scores.

According to a further aspect of this invention, a feedback process for providing feedback for unrecognized speech includes a speech input process for receiving a speech command as spoken by a user. An unrecognized speech comparison process, responsive to the speech input process, compares the user's speech command to a plurality of recognized speech commands available in a speech library to determine if the user's speech command is unrecognized speech, as opposed to non-speech. An unrecognized speech response process, responsive to the unrecognized speech comparison process determining that the user's speech command is unrecognized speech, generates a generic response which is provided to the user.

One or more of the following features may also be included. The generic response is a visual response. The generic response is an audible response.

According to a further aspect of this invention, a feedback process for providing feedback for unrecognized speech includes a speech input process for receiving a speech command as spoken by a user. An unrecognized speech comparison process, responsive to the speech input process, compares the user's speech command to a plurality of recognized speech commands available in a speech library to determine if the user's speech command is unrecognized speech, as opposed to non-speech. The unrecognized speech comparison process includes a user speech modeling process for performing an acoustical analysis of the user's speech command and generating a user speech acoustical model for the user's speech command. The unrecognized speech comparison process further includes a recognized speech modeling process for performing an acoustical analysis of each of the plurality of recognized speech commands and generating a recognized speech acoustical model for each recognized speech command, thus generating a plurality of recognized speech acoustical models.

One or more of the following features may also be included. The unrecognized speech comparison process further includes an acoustical model comparison process for comparing the user speech acoustical model to each of the recognized speech acoustical models, thus defining a plurality of acoustical scores which relate to the user's speech command, one score for each comparison performed. The unrecognized speech comparison process further includes an unrecognized speech window process for defining an acceptable range of acoustical scores indicative of unrecognized speech, wherein the user's speech command is defined as unrecognized speech if the acoustical score, chosen from the plurality of acoustical scores, which indicates the highest level of acoustical match falls within the acceptable range of acoustical scores. The plurality of recognized speech commands includes an unrecognized speech entry, the recognized speech modeling process further performs an acoustical analysis on the unrecognized speech entry to generate an unrecognized speech acoustical model for the unrecognized speech entry, and the acoustical model comparison process further compares the user speech acoustical model to the unrecognized speech acoustical model to define an unrecognized speech acoustical score. The user's speech command is defined as unrecognized speech if the unrecognized speech acoustical score indicates a higher level of acoustical match than any of the plurality of acoustical scores.

According to a further aspect of this invention, a feedback method for providing feedback for unrecognized speech includes: receiving a speech command as spoken by a user; and comparing the user's speech command to a plurality of recognized speech commands available in a speech library to determine if the user's speech command is unrecognized speech, as opposed to non-speech.

One or more of the following features may also be included. The feedback method further includes generating a generic response and providing it to the user if it is determined that the user's speech command is unrecognized speech. The comparing the user's speech command includes performing an acoustical analysis of the user's speech command and generating a user speech acoustical model for the user's speech command. The comparing the user's speech command further includes performing an acoustical analysis of each of the plurality of recognized speech commands and generating a recognized speech acoustical model for each recognized speech command, thus generating a plurality of recognized speech acoustical models. The comparing the user's speech command further includes comparing the user speech acoustical model to each of the recognized speech acoustical models, thus defining a plurality of acoustical scores which relate to the user's speech command, one score for each comparison performed. The comparing the user's speech command further includes defining an acceptable range of acoustical scores indicative of unrecognized speech, wherein the user's speech command is defined as unrecognized speech if the acoustical score, chosen from the plurality of acoustical scores, which indicates the highest level of acoustical match falls within the acceptable range of acoustical scores. The plurality of recognized speech commands includes an unrecognized speech entry. The comparing the user's speech command further includes: performing an acoustical analysis on the unrecognized speech entry to generate an unrecognized speech acoustical model and comparing the user speech acoustical model to the unrecognized speech acoustical model to define an unrecognized speech acoustical score. The user's speech command is defined as unrecognized speech if the unrecognized speech acoustical score indicates a higher level of acoustical match than any of the plurality of acoustical scores.

According to a further aspect of this invention, a computer program product residing on a computer readable medium having a plurality of instructions stored thereon which, when executed by the processor, cause that processor to: receive a speech command as spoken by a user; compare the user's speech command to a plurality of recognized speech commands available in a speech library to determine if the user's speech command is unrecognized speech, as opposed to non-speech; and generate a generic response and provide it to the user if it is determined that the user's speech command is unrecognized speech.

One or more of the following features may also be included. The computer readable medium is a random access memory (RAM), a read only memory (ROM), or a hard disk drive.

According to a further aspect of this invention, a processor and memory are configured to: receive a speech command as spoken by a user; compare the user's speech command to a plurality of recognized speech commands available in a speech library to determine if the user's speech command is unrecognized speech, as opposed to non-speech; and generate a generic response and provide it to the user if it is determined that the user's speech command is unrecognized speech.

One or more of the following features may also be included. The processor and memory are incorporated into a wireless communication device, a cellular phone, a personal digital assistant, a palmtop computer, or a child's toy.

The usability and enjoyability of devices incorporating voice recognition systems can be enhanced. Mispronunciations and incoherency will not adversely impact the enjoyability of these devices. Children's toys which incorporate voice recognition systems will be more enjoyable for younger users. This interest level that children have for these toys will be enhanced due to the voice recognition system providing feedback for all speech, even that speech which is garbled and unrecognized.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatic view of the feedback process for providing feedback for unrecognized speech;

FIG. 2 is a flow chart of the feedback method for providing feedback for unrecognized speech;

FIG. 3. is a diagrammatic view of another embodiment of the feedback process for providing feedback for unrecognized speech, including a processor and a computer readable medium, and a flow chart showing a sequence of steps executed by the processor; and

FIG. 4. is a diagrammatic view of another embodiment of the feedback process for providing feedback for unrecognized speech, including a processor and memory, and a flow chart showing a sequence of steps executed by the processor and memory.

Like reference symbols in the various drawings indicate like elements.

### DETAILED DESCRIPTION

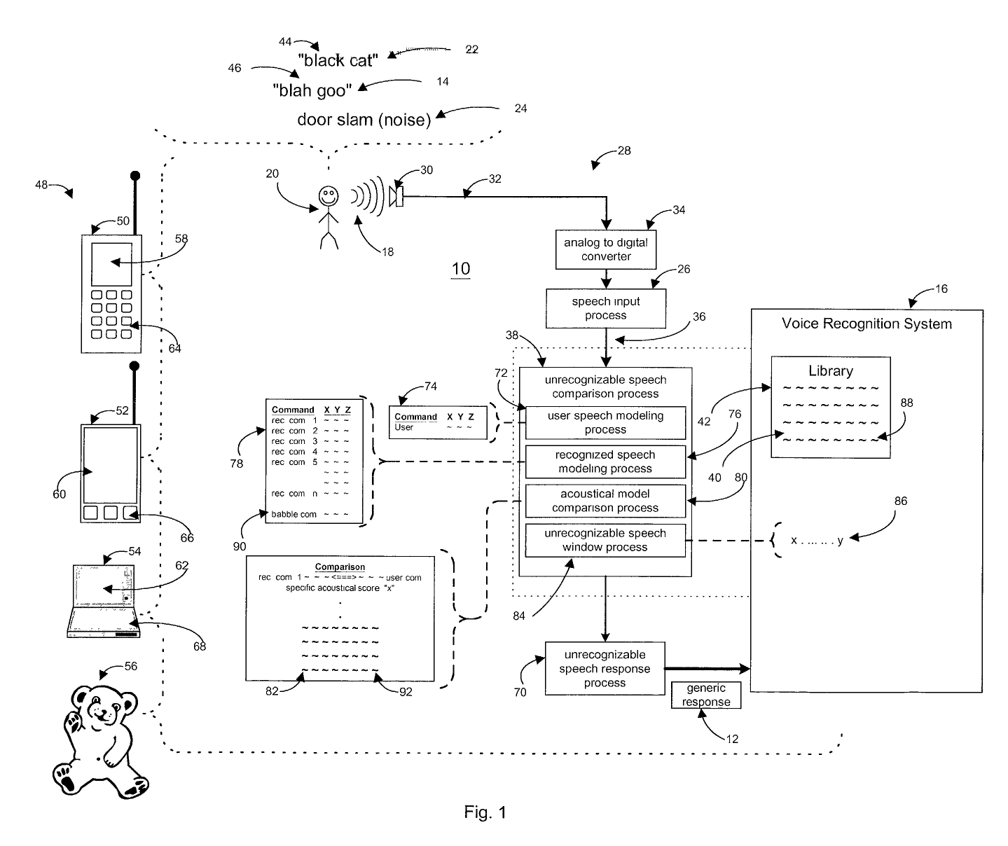

Referring to FIG. 1, there is shown a feedback process 10 for providing feedback 12 for unrecognized speech 14. Feedback process 10 is incorporated into or used in conjunction with voice recognition system 16 which evaluates the speech commands 18 provided by user 20 to determine if speech command 18 is recognizable speech 22, unrecognized speech 14, or non-speech 24.

Feedback process 10 includes speech input process 26 which receives speech command 18 from a source 28. Typically, source 28 is some combination of components which convert speech command 18 generated by user 20 into a signal useable by speech input process 26. Typical embodiments of these components include a microphone 30 for generating an analog voice signal which is provided on line 32 to analog-to-digital converter 34, which in turn generates a digital signal which is provided to speech input process 26. Alternatively, speech input process 26 may directly process the analog signal generated by microphone 30.

Speech input process 26 provides a signal (on line 36) representative of the speech command 18 spoken by user 20 to unrecognized speech comparison process 38. Unrecognized speech comparison process 38, which is responsive to speech input process 26, compares speech command 18 issued by user 20 to the plurality of recognized commands 40 available in the speech library 42 of voice recognition system 16 to determine if speech command 18 is unrecognized speech 14, as opposed to non-speech (or noise) 24.

Speech command 18 received by speech input process 26 will fall into one of three categories, namely: a) non-speech 24; b) unrecognized speech 14; or c) recognizable speech 22. Recognizable speech 22 is speech that voice recognition system 16 can clearly discern the specific and discrete words 44 incorporated into speech command 18. An example of recognizable speech 22 are the words “black cat”. Non-speech is not speech at all and is typically background noise (such as a door slamming or wind noise) or it may be background speech (such as a conversation that is taking place in the background and not intended to be an input signal to voice recognition system 16). Unrecognized speech 14 is speech in which voice recognition system 16 cannot unambiguously make a determination as to the specific and discrete words 46 which make up speech command 18.

Feedback process 10 may be incorporated into handheld devices 48 (such as cellular telephone 50 and personal digital assistant 52), computer 54 (e.g., palmtop, laptop, desktop, etc.), or child's toy 56. Cellular telephone 50, personal digital assistant 52 and computer 54 each include displays (58, 60 and 62 respectively) and some form of keyboard or keypad (64, 66 and 68 respectively).

An unrecognized speech response process 70, which is responsive to unrecognized speech comparison process 38 determining that speech command 18 is unrecognized speech 14, generates a generic response (i.e., feedback) 12 which is provided to user 20. This generic response can be in many forms depending on the type of device on which feedback process 10 is operating. A typical application for feedback process 10 would be to incorporate it (in combination with voice recognition system 16) into child's toy 56. In this application, user 20 would typically be a young child who quite often would still be in the process of learning how to speak. Child's toy 56 would be a learning toy which provides feedback to user 20 in response to user 20 stating specific words or asking specific questions. In the event that speech 18 provided by user 20 is recognizable speech 22, voice recognition system 16 will be able to discern the discrete words 44 included in recognizable speech 22 and, therefore, the appropriate response can be generated. An example of this exchange would be user 20 asking toy 56 “What is your name?, and toy 56 responding with “Yogi”. Naturally, as with any environment, there is always background noise (non-speech 24) present which voice recognition system 16 will ignore or discard. However, as it is probable that user 20 (i.e., a young child) will still be learning how to speak, it is foreseeable that user 20 will be issuing a considerable number of commands which are unrecognized speech 14. Accordingly, when this occurs, unrecognized speech response process 70 will generate generic response 12 which is provided to user 20. In this particular example, generic response 12 can be an audible response (such a toy 56 making some form of sound, such as a beep, a giggle, etc.). If generic response 12 is a visual response, it may be the eyes of toy 56 blinking or a light on toy 56 flashing.

As stated above, feedback process 10 may be incorporated in cellular telephone 50, personal digital assistant 52, or computer 54, and if generic response 12 is an audible response, a beep or some other form of sound can be generated by the internal speakers (not shown) incorporated into these devices (50, 52 and 54). In this particular example, if generic response 12 is, alternatively, a visual response, a prompt can be displayed on the display 58, 60 or 62 of either cellular telephone 50, personal digital assistant 52 or computer 54 respectively. An example of this prompt may be a text-based request that user 20 reiterate speech command 18.

As stated above, unrecognized speech comparison process 38 compares speech command 18 to a plurality of recognized speech commands 40 available in speech library 42 to determine if speech command 18 is unrecognized speech 14. There are various different comparisons or forms of analysis which can be performed, either alone or in combination, in order to make this determination. Examples of these forms of analysis are as follows: 1) analysis of vocal tract length (e.g.: linear and non-linear); 2) analysis of model parameters (e.g.: Maximum Likelihood Linear Regression); 3) analysis of dialect; 4) analysis of channel; 5) analysis of speaking rate; 6) analysis of speaking style; 7) analysis of language spoken; and 8) analysis of LOMBARD effect. Please realize that this list is not intended to be all-inclusive, is for illustrative purposes only, and is not intended to be a limitation of the invention.

The following articles and papers listed below further explain some of the various different forms of analysis which can be performed, and hereby are considered incorporated herein by reference:

F. Jelinek; “Statistical Methods for Speech Recognition”; The MIT Press, Cambridge, Mass.;

B. Gold; “Speech and Audio Signal Processing, Processing and Perception of Speech and Music”; John Wiley & Sons, Inc., New York, N.Y.;

M. Woszczyna; “Fast Speaker Independent Large Vocabulary Continuous Speech Recognition”; Dissertation of Feb. 13, 1998; University of Karlsruhe, Karlsruhe, Germany;

P. Zhan, and A. Waibel; “Vocal Tract Length Normalization for Large Vocabulary Continuous Speech Recognition”; School of Computer Science, Carnegie Mellon University, Pittsburgh, Pa.;

M. Westphal; “The Use of Cepstral Means in Conversational Speech Recognition”; Interactive Systems Laboratories, University of Karlsruhe, Karlsruhe, Germany;

J. Bilmes, N. Morgan, S. Wu, and H. Bourlard; “Stochastic Perceptual Speech Models with Durational Dependence”;

P. C. Woodland; “Speaker Adaptation: Techniques and Challenges”;

V. Digalakis, V. Doumpiotis, and S. Tsakalidis; “On the Integration of Dialect and Speaker Adaptation in a Multi-Dialect Speech Recognition System”;

V. Diakoloukas, and V. Digalakis; “Maximum-Likelihood Stochastic-Transformation Adaptation of Hidden Markov Models”; EDICS SA 1.6.7; Jan. 1998;

Regardless of the method of analysis performed, the manner in which unrecognized speech comparison process 38 and voice recognition system 16 determine if speech command 18 is unrecognized speech 14 is the same. An acoustical model for speech command 18 is compared to an acoustical model for each of the plurality of commands 40 stored on library 42 to generate a plurality of acoustical scores, where these acoustical scores are indicative of the level of acoustical match between speech command 18 and each of the plurality of commands 40 stored in library 42 of voice recognition system 16.

Unrecognized speech comparison process 38 includes a user speech modeling process 72 for performing an acoustical analysis (e.g., one of those listed above) on speech command 18 to generate a user speech acoustical model 74 for speech command 18. Acoustical model 74 provides an acoustical description of speech command 18. A recognized speech modeling process 76 performs, on each of the plurality of recognized speech commands 40, the same form of acoustical analysis to generate a recognized speech acoustical model for each recognized speech command analyzed, thus generating a plurality of recognized speech acoustical models 78. Again, these acoustical models 78 provides an acoustical description for each recognized speech command 40. Once these models are generated, an acoustical model comparison process 80 compares user speech acoustical model 74 to each of the plurality of recognized speech acoustical models 78, thus defining a plurality of acoustical scores 82 which relate to speech command 18., where this relationship is based on the fact that each of these acoustical scores 82 were generated by comparing the acoustical models 78 for each recognized command 40 to the acoustical model 74 for speech command 18. Therefore, a new plurality of acoustical scores 82 is generated for each subsequent speech command 18 provided by user 20. Provided the same form of analysis is performed on both user's speech command 18 and recognized speech commands 40 (which is required), the value of each of these acoustical scores 82 indicates the closeness of the acoustical match between the models which were compared in order to generate that particular acoustical score. Since one of these models 74 is always the model of the user's speech command 18 and the other model is a model for one of the plurality of recognized speech commands 40, the value of any of these acoustical scores indicates the level of acoustical match (i.e., acoustical similarity) between that particular recognized command and user's speech command 18. Accordingly, this level of acoustical similarity will determine the specific and discrete word (or words) that user 20 is saying.

Typically, each of the plurality of acoustical scores is a probability between 0.000 and 1.000, where: an acoustical score of 1.000 provides a 100% probability that user command 18 is identical to its related recognized command 40; an acoustical score of 0.000 provides a 0% probability that user command 18 is identical to its related recognized command 40; and an acoustical score somewhere between these two values specifies that related probability. By analyzing these acoustical scores (i.e., probabilities), certain determinations can be made. For example, thresholds can be established in which any probability over a specified threshold (e.g., 96.00%) is considered a definitive match. Accordingly, if a comparison between user's speech command 18 and one of the recognized commands 40 results in an acoustical score over this threshold, voice recognition system 16 and feedback process 10 will consider user's speech command 18 to be identical to the recognized command being analyzed. This command will then be considered recognized speech 22 for which the device into which voice recognition system 16 and feedback process 10 is incorporated into will take the appropriate action. As stated above, if the device is a child's toy 56 and the recognized speech 22 asked by child user 20 is the question “What is your name?”, toy 56 would respond by saying “Yogi” through an internal speaker (not shown).

Unrecognized speech 14 can be defined as speech whose acoustical score lies in a certain range under the threshold (e.g., 96.00%) of recognized speech. For example, acoustical scores in the range of 70.00% to 95.99% may be considered indicative of unrecognized speech, in which voice recognition system 16 and feedback process 10 realize that the input signal received by speech input process 26 is speech. However, the speech is so garbled or distorted that voice recognition system 16 cannot accurately determine the specific and discrete words which make up speech command 18, or speech command 18 is not in the recognition vocabulary. Additionally, input signals which fall below this range (i.e., in the range of 69.99% and below) can be considered non-speech 24. Please realize that for the above-described ranges, the only acoustical score (from the plurality of acoustical scores 82) that would be of interest is the highest acoustical score (or the acoustical score which indicates the highest level of acoustical match), as even a definitive acoustical match (i.e., a probability of 96.00% or greater) will have acoustical scores that fall into the range of unrecognized speech (70.00% to 95.99%) and acoustical scores which fall into the range of non-speech (69.99% and below). Further, please realize that the thresholds and ranges specified above are for illustrative purposes only and are not intended to be a limitation of the invention.

An unrecognized speech window process 84 defines the acceptable range of acoustical scores 86 (which spans from a low probability “x” to a high probability “y”) which is indicative of unrecognized speech 14. As stated above, an acoustical model is created (by recognized speech modeling process 76) for each recognized command 40 stored in library 42 of voice recognition system 16. Each of these acoustical models 78 is then compared (by acoustical model comparison process 80) to the acoustical model 74 for speech command 18 (as created by user speech modeling process 72). This series of comparisons results in a plurality of acoustical scores 82 which vary in probability. Naturally, the acoustical score that is of interest is the acoustical score (chosen from the plurality of acoustical scores 82) which shows the highest probability of acoustical match, as this will indicate the recognized command (selected from library 42) which has the highest probability of being identical to speech command 18 issued by user 20. Accordingly, if the acoustical score which shows the highest probability of acoustical match falls within acceptable range of acoustical scores 86, the user command 18 which generated this plurality of acoustical scores 82 is considered to be (i.e., defined) unrecognized speech 14.

Alternatively, an unrecognized speech (i.e., babble) entry 88 may be incorporated into library 42. Therefore, when recognized speech modeling process 76 generates the plurality of recognized speech acoustical models 78, an unrecognized speech (i.e., babble command) model 90 will be generated and included in this plurality 78. Alternatively, this unrecognized speech model 90 may be directly incorporated into recognized speech modeling process 76 and, therefore, not require a corresponding entry in library 42. Concerning unrecognized speech (i.e., babble command) model 90, it can be created to characterize unrecognized speech 14 based on the plurality of recognized commands 40 stored in library 42 or it can be created independent of this plurality of commands 40. Alternatively, model 90 may be created using a combination of both methods.

When acoustical model comparison process 80 compares the model 74 of speech command 18 to each acoustical model 78 of recognized commands 40 (including unrecognized speech model 90), an acoustical score 82 will be generated for each model that corresponds to speech commands 40 stored in library 42 and for unrecognized speech model 90. This will result in the plurality of acoustical scores 82 including an unrecognized speech acoustical score 92 which illustrates the level of acoustical match between speech command 18 and unrecognized speech model 90. Accordingly, if this score 92 illustrates a definitive and unambiguous match (e.g., greater that or equal to 96%) or a match which is greater than any of the other acoustical models, speech command 18 will be considered unrecognized speech 14 and, therefore, unrecognized speech output process 70 will generate the appropriate generic response 12.

Please realize that user speech modeling process 72, recognized speech modeling process 76, acoustical model comparison process 80, and unrecognized speech window process 84 may be stand alone processes or may be incorporated into voice recognition system 16. Further, the two methods for determining if speech command 18 is unrecognized speech 14 (namely, through the use of acceptable range of acoustical scores 86 or unrecognized speech model 90) are for illustrative purposes only and are not intended to be a limitation of the invention, as a person of ordinary skill in the art can accomplish this task using various other processes. For example, an alternative way of identifying and/or defining non-speech (or noise) 24 is to construct a non-speech model (not shown) which acoustically represents a specific form (or multiple forms) of noise (e.g., airplane noise, road noise, wind noise, air conditioning hiss, etc.). Accordingly, if there is a high level of acoustical match between the model 74 of speech command 18 and the non-speech model (not shown), it is likely that speech command 18 is actually the noise (e.g., airplane noise, road noise, wind noise, air conditioning hiss, etc.) represented by the non-speech model.

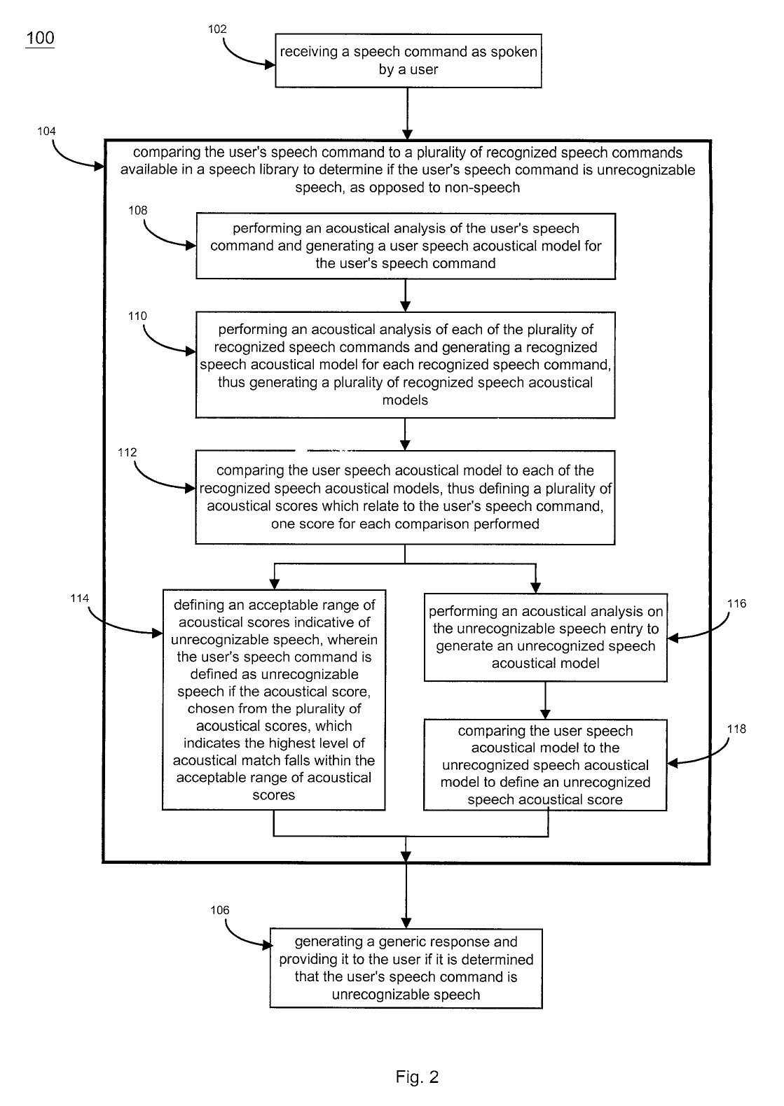

Referring to FIG. 2, there is shown a feedback method 100 for providing feedback for unrecognized speech. A speech input process receives 102 a speech command as spoken by a user. An unrecognized speech comparison process compares 104 the user's speech command to a plurality of recognized speech commands available in a speech library to determine if the user's speech command is unrecognized speech, as opposed to non-speech. An unrecognized speech response process generates 106 a generic response and provides it to the user if it is determined that the user's speech command is unrecognized speech. A user speech modeling process performs 108 an acoustical analysis of the user's speech command and generates a user speech acoustical model for the user's speech command. A recognized speech modeling process performs 110 an acoustical analysis of each of the plurality of recognized speech commands and generates a recognized speech acoustical model for each recognized speech command, thus generating a plurality of recognized speech acoustical models. An acoustical model comparison process compares 112 the user speech acoustical model to each of the recognized speech acoustical models, thus defining a plurality of acoustical scores which relate to the user's speech command, one score for each comparison performed. An unrecognized speech window process defines 114 an acceptable range of acoustical scores indicative of unrecognized speech, wherein the user's speech command is defined as unrecognized speech if the acoustical score, chosen from the plurality of acoustical scores, which indicates the highest level of acoustical match falls within the acceptable range of acoustical scores. A recognized speech modeling process performs 116 an acoustical analysis on a unrecognized speech entry to generate an unrecognized speech acoustical model. An acoustical model comparison process compares 118 the user speech acoustical model to the unrecognized speech acoustical model to define an unrecognized speech acoustical score. The user's speech command is defined as unrecognized speech if the unrecognized speech acoustical score indicates a higher level of acoustical match than any of the plurality of acoustical scores.

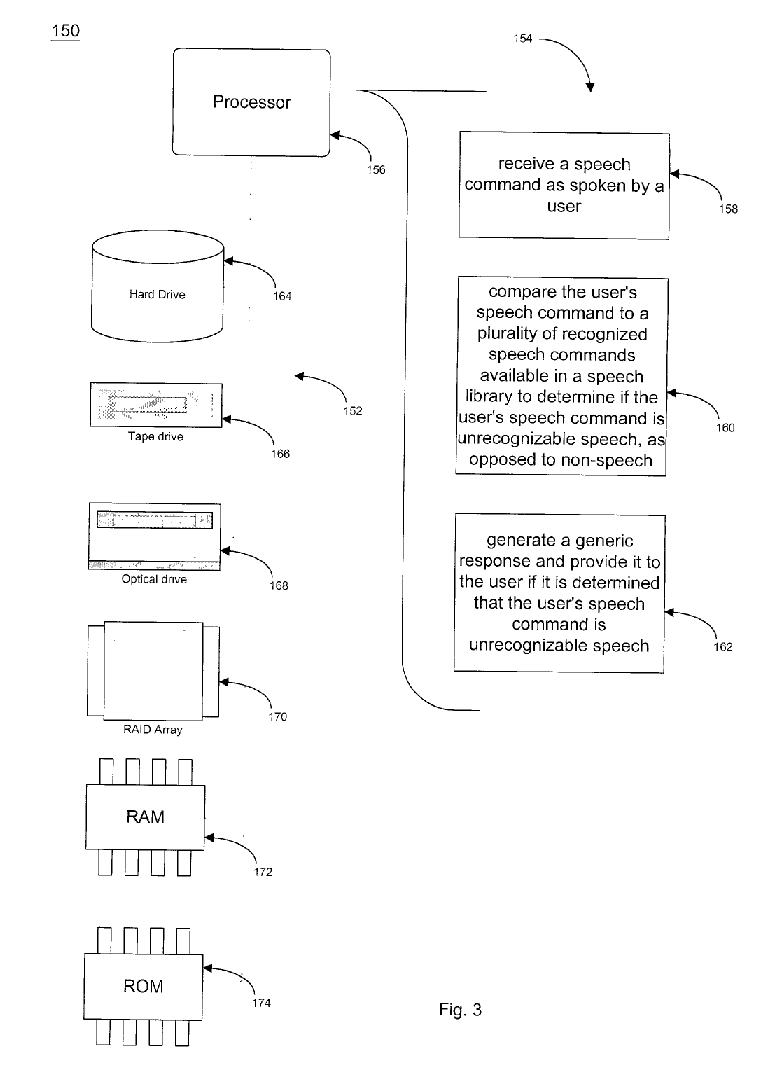

Referring to FIG. 3, there is shown a computer program product 150 residing on a computer readable medium 152 having a plurality of instructions 154 stored thereon which, when executed by the processor 156, cause that processor to: receive 158 a speech command as spoken by a user; compare 160 the user's speech command to a plurality of recognized speech commands available in a speech library to determine if the user's speech command is unrecognized speech, as opposed to non-speech; and generate 162 a generic response and provide it to the user if it is determined that the user's speech command is unrecognized speech.

Typical embodiments of computer readable medium 152 are: hard drive 164; tape drive 166; optical drive 168; RAID array 170; random access memory 172; and read only memory 174.

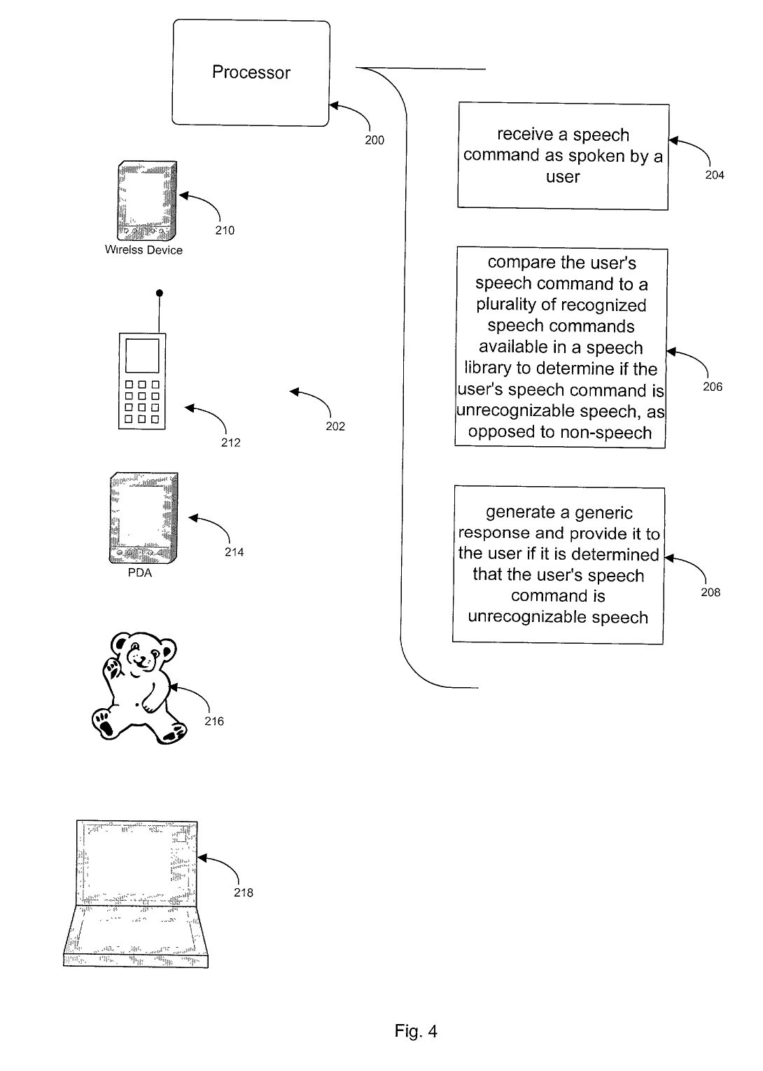

Referring to FIG. 4, there is shown a processor 200 and memory 202 configured to: receive 204 a speech command as spoken by a user; compare 206 the user's speech command to a plurality of recognized speech commands available in a speech library to determine if the user's speech command is unrecognized speech, as opposed to non-speech; and generate 208 a generic response and provide it to the user if it is determined that the user's speech command is unrecognized speech.

Processor 200 and memory 202 may be incorporated into a wireless communication device 210, cellular telephone 212, personal digital assistant 214, child's toy 216, palmtop computer 218, an automobile (not shown), a remote control (not shown), or any device which has an interactive speech interface.

A number of embodiments of the invention have been described. Nevertheless, it will be understood that various modifications maybe made without departing from the spirit and scope of the invention. Accordingly, other embodiments are within the scope of the following claims.

What is claimed is:

1. A feedback process for providing feedback for unrecognized speech comprising:
a speech input process for receiving a speech command as spoken by a user; and
an unrecognized speech comparison process, responsive to said speech input process, for comparing said user's speech command to a plurality of recognized speech commands available in a speech library to determine if said user's speech command is unrecognized speech, as opposed to non-speech.

2. The feedback process of claim 1 further comprising an unrecognized speech response process, responsive to said unrecognized speech comparison process determining that said user's speech command is unrecognized speech, for generating a generic response which is provided to said user.

3. The feedback process of claim 2 wherein said generic response is a visual response.

4. The feedback process of claim 2 wherein said generic response is an audible response.

5. The feedback process of claim 1 wherein said unrecognized speech comparison process includes a user speech modeling process for performing an acoustical analysis of said user's speech command and generating a user speech acoustical model for said user's speech command.

6. The feedback process of claim 5 wherein said unrecognizable speech comparison process further includes a recognized speech modeling process for performing an acoustical analysis of each of said plurality of recognized speech commands and generating a recognized speech acoustical model for each said recognized speech command, thus generating a plurality of recognized speech acoustical models.

7. The feedback process of claim 6 wherein said unrecognized speech comparison process further includes an acoustical model comparison process for comparing said user speech acoustical model to each of said recognized speech acoustical models, thus defining a plurality of acoustical scores which relate to said user's speech command, one said score for each said comparison performed.

8. The feedback process of claim 7 wherein said unrecognized speech comparison process further includes an unrecognized speech window process for defining an acceptable range of acoustical scores indicative of unrecognized speech, wherein said user's speech command is defined as unrecognized speech if the acoustical score, chosen from said plurality of acoustical scores, which indicates the highest level of acoustical match falls within said acceptable range of acoustical scores.

9. The feedback process of claim 7 wherein said plurality of recognized speech commands includes an unrecognized speech entry, said recognized speech modeling process further performs an acoustical analysis on said unrecognized speech entry to generate an unrecognized speech acoustical model for said unrecognized speech entry, and said acoustical model comparison process further compares said user speech acoustical model to said unrecognized speech acoustical model to define an unrecognized speech acoustical score; wherein said user's speech command is defined as unrecognized speech if said unrecognized speech acoustical score indicates a higher level of acoustical match than any of said plurality of acoustical scores.

10. A feedback process for providing feedback for unrecognized speech comprising:
a speech input process for receiving a speech command as spoken by a user;
an unrecognized speech comparison process, responsive to said speech input process, for comparing said user's speech command to a plurality of recognized speech commands available in a speech library to determine if said user's speech command is unrecognized speech, as opposed to non-speech; and
an unrecognized speech response process, responsive to said unrecognized speech comparison process determining that said user's speech command is unrecognized speech, for generating a generic response which is provided to said user.

11. The feedback process of claim 10 wherein said generic response is a visual response.

12. The feedback process of claim 10 wherein said generic response is an audible response.

13. A feedback process for providing feedback for unrecognized speech comprising:
a speech input process for receiving a speech command as spoken by a user; and
an unrecognized speech comparison process, responsive to said speech input process, for comparing said user's speech command to a plurality of recognized speech commands available in a speech library to determine if said user's speech command is unrecognized speech, as opposed to non-speech;
wherein said unrecognized speech comparison process includes a user speech modeling process for performing an acoustical analysis of said user's speech command and generating a user speech acoustical model for said user's speech command;
wherein said unrecognized speech comparison process further includes a recognized speech modeling process for performing an acoustical analysis of each of said plurality of recognized speech commands and generating a recognized speech acoustical model for each said recognized speech command, thus generating a plurality of recognized speech acoustical models.

14. The feedback process of claim 13 wherein said unrecognized speech comparison process further includes an acoustical model comparison process for comparing said user speech acoustical model to each of said recognized speech acoustical models, thus defining a plurality of acoustical scores which relate to said user's speech command, one said score for each said comparison performed.

15. The feedback process of claim 14 wherein said unrecognized speech comparison process further includes an unrecognized speech window process for defining an acceptable range of acoustical scores indicative of unrecognized speech, wherein said user's speech command is defined as unrecognized speech if the acoustical score, chosen from said plurality of acoustical scores, which indicates the highest level of acoustical match falls within said acceptable range of acoustical scores.

16. The feedback process of claim 14 wherein said plurality of recognized speech commands includes an unrecognized speech entry, said recognized speech modeling process further performs an acoustical analysis on said unrecognized speech entry to generate an unrecognized speech acoustical model for said unrecognized speech entry, and said acoustical model comparison process further compares said user speech acoustical model to said unrecognized speech acoustical model to define an unrecognized speech acoustical score; wherein said user's speech command is defined as unrecognized speech if said unrecognized speech acoustical score indicates a higher level of acoustical match than any of said plurality of acoustical scores.

17. A feedback method for providing feedback for unrecognized speech comprising:
receiving a speech command as spoken by a user; and
comparing the user's speech command to a plurality of recognized speech commands available in a speech library to determine if the user's speech command is unrecognized speech, as opposed to non-speech.

18. The feedback method of claim 17 further comprising generating a generic response and providing it to the user if it is determined that the user's speech command is unrecognized speech.

19. The feedback method of claim 17 wherein said comparing the user's speech command includes performing an acoustical analysis of the user's speech command and generating a user speech acoustical model for the user's speech command.

20. The feedback method of claim 19 wherein said comparing the user's speech command further includes performing an acoustical analysis of each of the plurality of recognized speech commands and generating a recognized speech acoustical model for each recognized speech command, thus generating a plurality of recognized speech acoustical models.

21. The feedback method of claim 20 wherein said comparing the user's speech command further includes comparing the user speech acoustical model to each of the recognized speech acoustical models, thus defining a plurality of acoustical scores which relate to the user's speech command, one score for each comparison performed.

22. The feedback method of claim 21 wherein said comparing the user's speech command further includes defining an acceptable range of acoustical scores indicative of unrecognizable speech, wherein the user's speech command is defined as unrecognized speech if the acoustical score, chosen from the plurality of acoustical scores, which indicates the highest level of acoustical match falls within the acceptable range of acoustical scores.

23. The feedback method of claim 21 wherein the plurality of recognized speech commands includes an unrecognized speech entry, wherein said comparing the user's speech command further includes:
performing an acoustical analysis on the unrecognized speech entry to generate an unrecognized speech acoustical model; and
comparing the user speech acoustical model to the unrecognized speech acoustical model to define an unrecognized speech acoustical score;
wherein the user's speech command is defined as unrecognized speech if the unrecognized speech acoustical score indicates a higher level of acoustical match than any of the plurality of acoustical scores.

24. A computer program product residing on a computer readable medium having a plurality of instructions stored thereon which, when executed by the processor, cause that processor to:
receive a speech command as spoken by a user;
compare the user's speech command to a plurality of recognized speech commands available in a speech library to determine if the user's speech command is unrecognized speech, as opposed to non-speech; and
generate a generic response and provide it to the user if it is determined that the user's speech command is unrecognized speech.

25. The computer program product of claim 24 wherein said computer readable medium is a random access memory (RAM).

26. The computer program product of claim 24 wherein said computer readable medium is a read only memory (ROM).

27. The computer program product of claim 24 wherein said computer readable medium is a hard disk drive.

28. A processor and memory configured to:
receive a speech command as spoken by a user;
compare the user's speech command to a plurality of recognized speech commands available in a speech library to determine if the user's speech command is unrecognized speech, as opposed to non-speech; and
generate a generic response and provide it to the user if it is determined that the user's speech command is unrecognized speech.

29. The processor and memory of claim 28 wherein said processor and memory are incorporated into a wireless communication device.

30. The processor and memory of claim 28 wherein said processor and memory are incorporated into a cellular phone.

31. The processor and memory of claim 28 wherein said processor and memory are incorporated into a personal digital assistant.

32. The processor and memory of claim 28 wherein said processor and memory are incorporated into a palmtop computer.

33. The processor and memory of claim 28 wherein said processor and memory are incorporated into a child's toy.
